(19) United States
(12) Patent Application Publication
(10) Pub. No.: US 2024/0429959 A1
(43) Pub. Date: Dec. 26, 2024

(54) Method and device for controlling the operation of a wireless communication device

(71) Applicant: ORANGE, ISSY-LES-MOULINEAUX (FR)

(72) Inventors: Laurent Coiffard, CHATILLON CEDEX (FR); Momar Goumballe, CHATILLON CEDEX (FR)

(21) Appl. No.: 18/753,390

(22) Filed: Jun. 25, 2024

(30) Foreign Application Priority Data
Jun. 26, 2023 (FR) 2306622

(51) Int. Cl. H04B 1/3827; H04B 7/0404; H04B 7/06; H04W 52/28; H04W 52/36

(52) U.S. Cl. CPC H04B 1/3838; H04B 7/0404; H04B 7/0608; H04W 52/283; H04W 52/367

(57) ABSTRACT

A method for controlling the operation of a wireless communication device including a plurality of antennas configured to spatially radiate in separate areas. The method includes alternating selecting of the antennas to transmit a communication signal. The selecting is performed so that the average specific absorption rate generated by each antenna over a given time period and also considering a given “control distance” between the communication device and a human body is less than a determined threshold.

### CROSS-REFERENCE TO RELATED APPLICATIONS

This application claims priority to and the benefit of French Patent Application No. FR2306622, filed Jun. 26, 2023, the content of which is incorporated herein by reference in its entirety.

### PRIOR ART

This disclosure relates to the general field of telecommunications. It more specifically relates to a method for controlling the operation of a wireless communication device, along with a control device configured to implement said control method. It also relates to a wireless communication device equipped with said control method. The application has a particularly advantageous, although in no way limiting, application in the case where the wireless communication device is a mobile phone, particularly a smartphone.

In the aim of protecting peoples' health from potentially adverse effects generated by exposure to radio waves (i.e. electromagnetic waves propagating by wireless means and the frequencies of which are contained in the conventional spectrum ranging from a few Hertz to a few hundred gigahertz), different regulations have been introduced in certain territories/countries.

Most of these regulations, particularly those in effect in Europe and in the United States, have the common feature of imposing limits on exposure to radio waves using a so-called “Specific Absorption Rate” index, also currently known by its acronym SAR.

In a known manner, the SAR corresponds to a measurement indicating the power of a flow of energy conveyed by the radio waves transmitted by a wireless communication device (mobile phone, tablets, smart watch for example) and absorbed by a human body, in principle the user of said device, when the device operates at a given emissive power level (typically at full emissive power).

In the International System of units, the unit of measurement of the SAR is the Watt per kilogram (W/kg). The measurement of the SAR is done in a manner known per se, namely using, for example, a measurement bench equipped with a human-like dummy filled with liquid having the same dielectric properties as that of the human body.

In general, the imposed exposure limits on the SAR are broken down by area of the body concerned. By way of example, and more specifically as regards the European regulations applicable to any communication device able to transmit at a frequency between 100 kHz and 10 GHz at a distance less than or equal to 20 cm of the human body and using an emissive power greater than or equal to 20 mW, the current exposure limits are as follows:
for the head or torso, SAR of 2 W/kg over a 10 g sample of human matter by instantaneous measurement if the emissive power is stable or else a measurement averaged over a time period equal to 6 minutes,
for limbs (arms, legs), SAR of 4 W/kg over a 10 g sample of human matter by instantaneous measurement if the emissive power is stable or else by measurement averaged over a time period equal to 6 minutes.

It should be noted that these European exposure limits are defined for a given distance between the emitting communication device and the human body. Thus, as regards limbs, the distance is of 0 mm. For the head, the distance is also of 0 mm (it being understood that the communication device is positioned on the dummy very accurately, with a calibration and an angle which are indicated in the standard). Finally, as regards the torso, the distance considered until recently was equal to 5 mm. However, with a view to imposing a greater limitation on exposure level, it was decided that the distance considered for measurement of the SAR at the torso will soon be zero.

In general, both in Europe and in other territories, the regulations related to electromagnetic field exposure levels are becoming more stringent, which thus imposes ever-increasing limitations on the SAR levels to which a user can be exposed, either in terms of measurement distances and/or SAR limit values.

Faced with this situation, one solution that can be envisioned to comply with ever more restrictive exposure limits could be to reduce the maximum emissive power of a wireless communication device.

However, this solution remains problematic insofar as it gives rise to a drop in the uplink speed, and therefore ultimately a lower quality of service.

One possible theoretical way of at least partially compensating for these drawbacks could optionally consist in massive investments by communications operators, particularly by considerably increasing the number of base stations implanted. Here again, this solution remains problematic due to its cost of implementation, in financial terms as well as in terms of hardware and ground surface occupied.

### SUMMARY

A first aspect of the present disclosure relates to a method for controlling the operation of a wireless communication device including a plurality of antennas configured to spatially radiate in separate areas. Said method includes a step of alternating selecting of said antennas to transmit a communication signal, said selecting being performed so that the average specific absorption rate generated by each antenna over a given time period and also considering a given distance, the so-called “control distance”, between the communication device and the human body is less than a determined threshold.

Thus, the control method according to an exemplary aspect makes it possible to alternatively and spatially distribute the emissive power of the wireless communication device between the antennas. In other words, the wireless communication device transmits a signal of communication at a constant power, such as for example its maximum emissive power, which makes it possible to ensure an excellent uplink speed, and therefore an excellent quality of service.

Moreover, and as the fundamental point of differentiation from the prior art, these excellent communication performances are achieved while observing a SAR threshold, which can for example be derived from exposure limits imposed in the framework of a regulative restriction.

In other words, the fact of using the antennas of the wireless communication device (configured to radiate spatially in separate areas) in an alternating manner advantageously makes it possible to include the requirement to observe exposure limits while guaranteeing excellent communication performances. This advantageous result is also cheap to achieve in terms of production costs.

In particular embodiments, the control method can further include one or more of the following features, taken in isolation or in any technically possible combination.

In particular embodiments, the number of antennas is strictly greater than two.

In particular embodiments, the emissive power used by a selected antenna is the maximum emissive power of the wireless communication device.

In particular embodiments, the method includes a step of evaluating a distance between the communication device and the human body, the execution of the selecting step being consequent on the fact that said evaluated distance is less than a given threshold.

In particular embodiments, the method includes a step of evaluating the emissive power used by an antenna in use to transmit said communication signal, the execution of the selecting step being consequent on the fact that said evaluated emissive power is greater than a given threshold.

In particular embodiments, the step of evaluating the emissive power includes a set of evaluations of the emissive power by respectively considering a set of control distance values, said evaluated emissive power being equivalent to the maximum emissive power obtained from said set of evaluations of the emissive power.

For example, the emissive power can be evaluated for 0 mm, 1 mm, 2 mm, 3 mm, 4 mm and 5 mm from the human body, the maximum emissive power value being considered as being the emissive power used to compare it to a threshold distance and as a function of the comparison to implement the selecting step or not.

In particular embodiments, the alternating selecting of the antennas is performed with a fixed or dynamic periodicity.

In particular embodiments, the communication signal is a mobile phone signal or a Wi-Fi signal or a Bluetooth signal.

In particular embodiments, said control distance is zero.

In particular v, said time period is equal to six minutes.

In particular embodiments, the threshold of said average specific absorption rate is equal to 2 W/kg.

In particular embodiments, the maximum emissive power of the communication device is greater than or equal to 20 mW.

A second aspect relates to a computer program including instructions for implementing a control method according to the disclosure when said computer program is executed by a computer.

This program can use any programming language, and be in the form of source code, object code, or intermediate code between source code and object code, such as in a partially compiled form, or in any other desirable form.

A third aspect relates to an information or recording medium readable by a computer, on which is recorded a computer program according to the disclosure.

The information or recording medium can be any entity or device capable of storing the program. For example, the medium can include a storage means, such as a ROM, for example a CD-ROM or a microelectronic circuit ROM, or else a magnetic recording means, for example a hard disc.

Moreover, the information or recording medium can be a transmissible medium such as an electrical or optical signal, which can be conveyed via an electrical or optical cable, by radio or by other means. The program according to the disclosure can in particular be downloaded over a network of Internet type.

Alternatively, the information or recording medium can be an integrated circuit into which the program is incorporated, the circuit being suitable for executing or for being used in the execution of the method in question.

A fourth aspect relates to a control device including means configured to implement a control method according to the disclosure.

A fifth aspect relates to a wireless communication system including a plurality of antennas configured to spatially radiate in separate areas and also a control device according to the disclosure.

A sixth aspect relates to a communication method implemented by a wireless communication device according to the disclosure.

### BRIEF DESCRIPTION OF THE DRAWINGS

Other features and advantages of the present disclosure will become apparent from the description given below, with reference to the appended drawings which illustrate an exemplary embodiment thereof without any limitation. In the figures:

FIG. 1 schematically represents a particular embodiment of a wireless communication device according to the disclosure;

FIG. 2 schematically represents an example of a hardware architecture of a control device according to the disclosure incorporated into the wireless communication device of FIG. 1;

FIG. 3 represents, in the form of a flow chart, a particular mode of implementation of a communication method, the so-called “general method”, implemented by the wireless communication device of FIG. 1, said general method encompassing a control method according to the disclosure implemented by the control device of FIG. 2;

FIGS. 4a and 4b illustrate a specific example of application of the communication method of FIG. 3, where:

FIG. 4a is a graph showing variation over time of average SAR along with the instantaneous SAR for a first antenna; and

FIG. 4b is a graph showing variation over time of the instantaneous SAR for a second antenna.

### DETAILED DESCRIPTION OF EXEMPLARY EMBODIMENTS

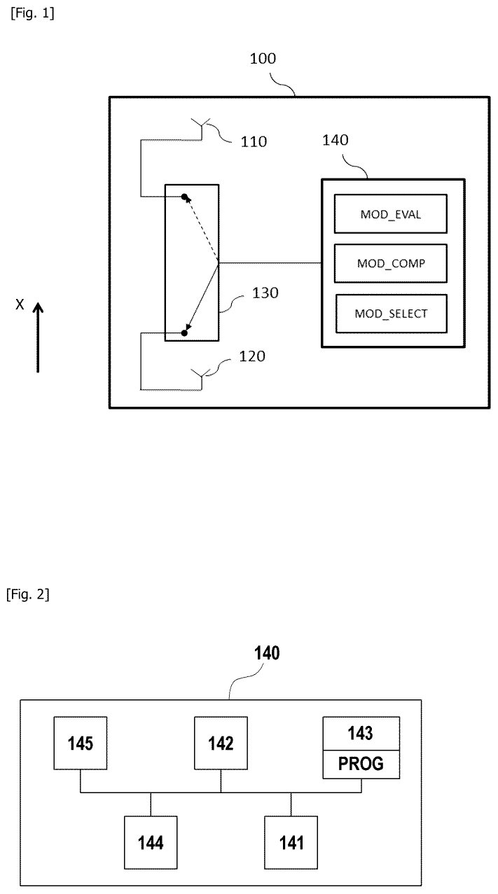

FIG. 1 schematically represents a particular embodiment of a wireless communication device 100 according to the disclosure.

For the rest of the description, the concepts of “top” and “bottom” are defined in relation to the vertical axis X represented on FIG. 1, it being understood that the direction in which said axis X is pointing denotes the “top”.

It is also considered without any limitation that the wireless communication device 100 is a smartphone belonging to a user, and that the communication device 100 is equipped with two antennas, a first antenna 110 and a second antenna 120. It is moreover considered that the maximum emissive power of the wireless communication device 100 (i.e. the maximum power that can be used on each antenna 110, 120 to transmit a communication signal) is greater than or equal to 20 mW.

More specifically, and as illustrated by FIG. 1, the antennas 110, 120 are incorporated into the structure of the device 100, for example at its periphery. Furthermore, the antennas 110, 120 are configured to spatially radiate in separate areas of the device 100 (i.e. the first and second antennas 110, 120 are non-colocated). Thus, the first antenna 110 (or second antenna respectively 120) is configured to radiate toward the top (or the bottom respectively) of the wireless communication device 100. It should be noted that this difference in the spatial orientation of the first and second antennas 110, 120 entails, in the embodiment under consideration here, that the first antenna 110 (or second antenna 120 respectively) first and foremost radiates level with the head of the user (or level with the torso of the user respectively).

It should however be noted that these dispositions are not limitations of the disclosure. In particular, no limitation is attached to the nature of the device 100 as long as the latter is able to make wireless communications. For example, as an alternative to a smartphone, it can be a digital tablet, a laptop computer, a personal assistant, a smart watch, an electronic smoother, etc.

In the same way, no limitation is attached to the maximum emissive power of the wireless communication device 100. Note however that the maximum emissive power can allow for an upper bound due to the existence of a communication standard imposed locally by a regulation, this upper bound depending on the frequency band used to communicate. These aspects being well-known to those skilled in the art, they will not be further detailed here.

Nor does the number of antennas constitute a limitation of the disclosure as long as a plurality is able to radiate in separate areas. In other words, nothing precludes considering several antennas able to radiate in identical (or substantially identical) areas of the wireless communication device 100, as long as, out of all the antennas equipping said device 100, at least two of these antennas are able to radiate in separate areas. Specifically, and as will be described in detail further on, said at least two antennas able to radiate in separate areas are intended to be used specifically to limit the specific absorption rate generated during the emission of a communication signal.

Moreover, in this embodiment, the device 100, and therefore in particular the first and second antennas 110, 120, are configured to transmit and receive communication signals which are 4G mobile telephony signals. It should however be specified that the present disclosure remains applicable to other types of communication signal, such as for example of mobile telephony signals other than 4G (for example 2G, 3G, 5G, but also 6G when it will be available), Wi-Fi signals, WiMax signals, Bluetooth signals, etc. In general, no limitation is attached to the communication signals that can be considered in the context of this disclosure as long as they are radio signals.

Besides said first and second antennas 110, 120, the wireless communication device 100 is configured in hardware and software form to transmit and receive said communication signals. For this purpose, and conventionally, the device 100 includes at least one transmission line and at least one reception line (not shown in the figures). Each transmission line for example includes a digital-to-analog converter, a modulator and a power amplifier. Meanwhile, each reception line for example includes a low noise amplifier, a demodulator and an analog-to-digital converter.

The device 100 also includes an electrical signal processing unit (not shown in the figures), currently known as a DSP (Digital Signal Processor) unit and configured to generate baseband signals intended to be conveyed to the antennas 110, 120 via said at least one transmission line as well as to process signals received by the antennas 110, 120 and conveyed to said DSP unit via said at least one reception line.

The wireless communication device 100 also includes switching means 130 able to selectively connect the first antenna 110 or else the second antenna 120 to a transmission/reception line in order to allow the transmission/reception of a communication signal. Such switching means 130 are of a design known per se. By way of in no way limiting example, this can be a duplexer or else a selector switch.

In general, those skilled in the art know the conventional architecture of a wireless communication device suitable for the transmission/reception of radio signals, although these aspects will not be further detailed here.

The wireless communication device 100 further includes a control device 140 implementing processing with the aim of controlling the operation of the device 100 so as to limit the time-averaged SAR generated by each of said antennas 110, 120, and implementing a method for controlling the operation of said device 100.

FIG. 2 schematically represents an example of a hardware architecture of the control device 140 incorporated into the wireless communication device 100 of FIG. 1.

As illustrated by FIG. 2, the control device 140 has the hardware architecture of a computer. Thus, the control device 140 includes, in particular, a processor 141, a random access memory 142, a read-only memory 143 and a non-volatile memory 144. It also has communication means 145.

The read-only memory 143 of the control device 140 constitutes a recording medium in accordance with an aspect of the disclosure, readable by the processor 141 and on which is recorded a computer program PROG in accordance with the disclosure, a computer program PROG in accordance with the disclosure, including instructions for executing steps of the control method. The program PROG defines functional modules of the control device 140, which are based on or control the hardware elements 141 to 145 of the control device 140 mentioned previously. These functional modules are illustrated in FIG. 1 without any limitation, and are described in more detail below with reference to different embodiments.

The communication means 145 in particular allow the device 141 to transmit command signals to the switching means 130 in order to select either the first antenna 110 or the second antenna 120 (i.e. in order to selectively connect either the first antenna 110 or the second antenna 120 to a transmission/reception line to allow the transmission/reception of a communication signal). For this purpose, the communication means 145 can for example include a computer data bus suitable for transmitting said command signals. Alternatively, said command signals can be transmitted via a communication interface, wired or wireless, able to implement any suitable protocol known to those skilled in the art. Moreover, the communication means 145 also include the first and second antennas 110, 120.

It should be noted that in the embodiment described here with reference to FIGS. 1 and 2, it is considered that the control device 140 is an element external to the general processor (not shown on the figures) of the wireless communication device 100 (such a general processor is also known as a “chipset” or else a “SoC (System on Chip)”. Of course, such provisions are not limiting to the disclosure, and nothing precludes considering other embodiments in which the control device 140 is incorporated into said general processor.

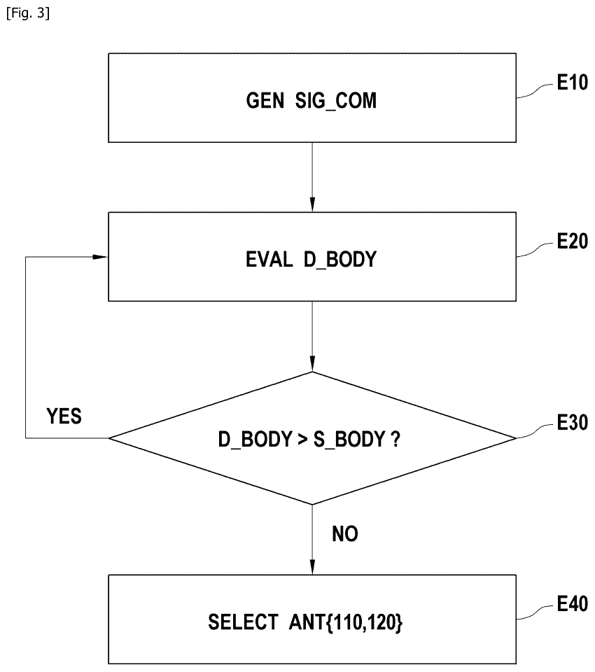

FIG. 3 shows, in the form of a flow chart, a particular mode of implementation of a communication method, the so-called “general method”, implemented by the wireless communication device 100. Said generally method encompasses the control method according to the disclosure implemented according to the disclosure implemented by the control device 140 of FIG. 2.

As mentioned above, the SAR considered in the context of this disclosure is a time-averaged SAR, also known as “average SAR”. The time average of the SAR is taken over a given time period T_DAS. Moreover, conventionally, said average SAR is evaluated by considering a given distance, the so-called “control distance” D_DAS, between the communication device 100 and the human body (i.e. the body of the user of said device 100).

Thus, for the description of this mode of implementation of the communication method, and therefore a fortiori of the control method, one considers without any limitation an emission of a communication signal 4G in a specific context of regulatory restriction, for example a regulatory restriction resulting from a piece of national legislation. This regulatory restriction imposes exposure limits in terms of average SAR on both antennas 110, 120. More specifically, these exposure limits are expressed here as follows:
the time period T_DAS considered for the average SAR is equal to six minutes,
the maximum threshold S_DAS (i.e. the threshold that must not be exceeded) in terms of average SAR is equal to 2 W/kg for 10 g of human matter,
the control distance D_DAS is zero. It should be noted that the fact of having a zero control distance D_DAS equates to considering the most stringent possible regulation in terms of distance, so comparable to what is, for example, now practiced in Europe for the head and the torso.

It is however important to note that the values of the parameters taken into account to define the exposure limits constitute only one variant implementation of the disclosure, and nothing precludes considering other values, either in terms of time period and/or maximum threshold and/or control distance. In particular, it is understood that this or these values can come from a communication standard imposed by regulations in a given geographic area (e.g. in the United States, the time period under consideration is equal to 1 minute and 30 seconds). According to another example, the control distance can have a value between 0 and 5 mm.

Moreover, the parameters that are taken into account in this mode of implementation are applicable to all the antennas of the wireless communication device 100, so in particular to the first and second antennas 110, 120, in order to define exposure limits common to all said antennas. However, here again, such provisions are not limiting of the disclosure, and nothing precludes considering different values of time period and/or maximum threshold and/or control distance such as to define the exposure limits specific to each antenna (e.g. one may set a threshold of 2 W/kg for the antenna or antennas radiating in the direction of the torso and the head, and another threshold of 4 W/kg for the antenna or antennas radiating in the direction of the limbs).

Finally, it will moreover be considered that when the communication method begins, the switching means 130 are initially configured to connect the second antenna 120 to a transmission line of the wireless communication device 100.

As illustrated by FIG. 3, the communication method first includes a step E10 of generating a communication signal SIG_COM. Said step E10 is implemented by the wireless communication device 100, more specifically by the DSP unit described above.

This generation of the communication signal SIG_COM is performed, for example, after the dialing of a telephone number by the user of the device 100, to enter into communication with the user of another smartphone to which said telephone number is assigned.

Insofar as the switching means 130 connect the second antenna 120 to a transmission line when the signal SIG_COM is generated, it is this second antenna 120 that is intended to be used first to transmit said signal SIG_COM.

In the mode of implementation described here with reference to FIG. 3, the communication method also includes a step E20 of evaluating a distance D_BODY between the wireless communication device 100 and the body of the user of said device 100. Said step E20 is implemented by a module MOD_EVAL equipping the control device 140, and is part of the control method.

It will specifically be understood that when the user of the device 100 dials the number to be called, the device 100 is distant from the body of said user. Once the number has been dialed, the user carries the device 100 level with his ear or another part of the body, such that the distance D_BODY decreases until it becomes zero.

Also, during the execution of the step E30, the communication method also includes a step E30 of comparing the distance D_BODY with a given threshold S_BODY. Said step E30 is implemented by a module MOD_COMP equipping the control device 140, and is part of the control method.

No limitation is attached to the value of said threshold S_BODY, which can for example be in the order of the tenth of a centimeter or of the centimeter (e.g. 20 cm, 10 cm, 5 cm), or else in the order of the tenth of millimeter or of the millimeter (e.g. 20 mm, 10 mm, 5 mm).

As illustrated by FIG. 3, said steps E20 and E30 are iterated as long as the distance D_BODY remains greater than the threshold S_BODY. Also, and as mentioned above, the user carries the device 100 to his ear, such that the distance D_BODY at some point in time becomes zero, and therefore less than (or equal) to the threshold S_BODY, which triggers the execution of a step E40 of alternative selecting of the first and second antennas 110, 120 to transmit the communication signal SIG_COM. Said step E40 is implemented by a selecting module MOD_SELECT equipping the control device 140, and is part of the control method.

The alternating selecting of the antennas 110, 120 for the transmission of the signal SIG_COM (i.e. their respective connection to a transmission line using the communication means 130) is carried out so that the average SAR generated by each antenna 110, 120 over the time period T_DAS and also considering the control distance D_DAS is less than the threshold S_DAS.

As mentioned above, the selecting of the antennas 110, 120 in accordance with the step E40 includes the sending of appropriate command signals to the switching means 130, so as to selectively connect said antennas 110, 120 to a transmission line.

In this mode of implementation, the emissive power used by a selected antenna 110, 120 (i.e. an antenna 110, 120 connected to a transmission line using the switching means 130) is the maximum emissive power of the wireless communication device 100.

However, the fact of considering one maximum emissive power per each selected antenna constitutes only one variant of implementation of the disclosure. Specifically, nothing precludes the consideration of other variants in which the emissive power of one or more antennas can be modulated during the different selections of said or said antennas, as long as the average SAR remains less than the threshold S_DAS for said antenna or antennas.

Moreover, in this embodiment, the alternating selecting of the antennas 110, 120 is performed with a fixed periodicity.

No limitation is attached to the value of this fixed periodicity as long as the average SAR remains less than the threshold S_DAS for said antenna or antennas.

Alternatively, nothing precludes the alternative selection of the antennas 110, 120 being implemented with a dynamic (i.e. time-variable) periodicity as long as the average SAR remains less than the threshold S_DAS for said antenna or antennas. For example, the alternative selection can be implemented with a dynamic periodicity as a function of information blocks to be transmitted, for example as a function of radio signals to be transmitted, also known as “bursts”, it being understood that the switching of the antennas is preferably carried out between two bursts in order to limit the loss of information to be transmitted.

It should be noted that the periods (or instants) of selection of the antennas, and also the powers used by each antenna can in particular be determined following lab test campaigns. These periods (or instants) and powers are then recorded in a memory of the control device 140 (e.g. the non-volatile memory 144) to be used during the implementation of the control method.

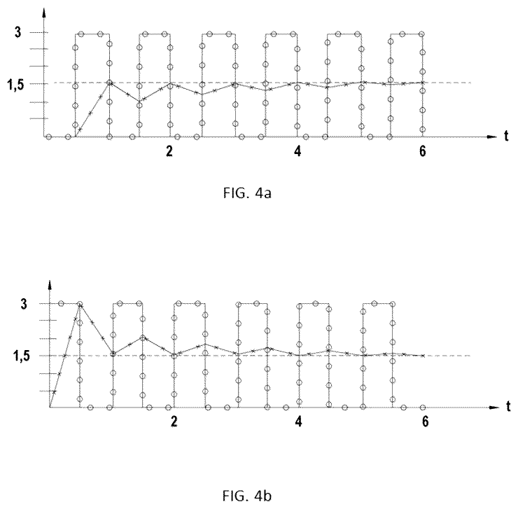

FIG. 4 illustrates a specific example of application of the communication method of FIG. 3.

More specifically, FIG. 4 includes two sub-FIGS. 4a, 4b. The sub-FIG. 4a is a graph showing the variation over time (time t on the abscissae) of the average SAR (solid line with crosses) along with the instantaneous SAR (solid line with circles) for the first antenna 110.

Sub-FIG. 4b, meanwhile, is a graph showing the variation over time (time t on the abscissae) of the instantaneous SAR (solid line with circles) for the second antenna 120.

In the example of FIG. 4, the periodicity of selection of the first and second antennas 110, 120 is fixed and equal to 30 seconds (the second antenna 120 transmits for the 30 first seconds, then the first antenna 110 transmits for the following 30 seconds, and so on). Furthermore, said first and second antennas 110, 120, when they are selected, use the maximum emissive power of the wireless communication device 100 to transmit the signal SIG_COM.

As can be seen on each of the sub-FIGS. 4a, 4b, the average SAR generated by each of the antennas 110, 120 is less than S_DAS (=2 W/kg) at the end of the period T_DAS (=6 minutes). In other words, the alternative selection of the first and second antennas 110, 120 advantageously makes it possible to comply with the exposure limits while exploiting the maximum power of the wireless communication device 100, which makes it possible to ensure an excellent uplink speed, and therefore an excellent quality of service.

It should be noted that the communication method, and therefore a fortiori the control method, have been described considering a wireless communication device 100 equipped with two antennas 110, 120. However, and as already mentioned above, this number of antennas is not limiting of the disclosure, and nothing precludes considering more than two antennas, and therefore an alternative selection (step E40) between more than two antennas, as long as the average SAR generated by an antenna remains less than the threshold S_DAS. In this case, the alternative selection is preferably performed sequentially between the different antennas.

The control method has also been described until now by considering the implementation of the steps E20 and E30 to evaluate the distance D_BODY and compare it to the threshold S_BODY, so as to form a condition of the triggering of the step E40 of alternative selection of the antennas 110, 120. Thus, and firstly, it will be understood that if the distance D_BODY remains greater than the threshold S_BODY at a given moment in time, this can interrupt the alternative selection of the antennas 110, 120. Alternatively, the alternating selection is not interrupted even if the distance D_BODY rises back above the threshold S_BODY, for example for safety reasons.

Secondly, it is important to note that the implementation of the steps E20 and E30 is optional within the meaning of the disclosure. In yet other words, the invention covers embodiments in which the alternative selection of the antennas is performed independently of the value of the distance D_BODY.

Nor does anything preclude considering embodiments in which the triggering of the alternative selection of the antennas is conditional on something different. For example, the control method can include a step of evaluating the emissive power used by an antenna in use to transmit the communication signal (e.g. the second antenna 120 in the example of FIG. 3, given that it is the antenna connected to a transmission line before the implementation of the control method.) Hence, the execution of the selecting step is consequent on the fact that said evaluated emissive power is greater than a given threshold.

Furthermore, although the evaluation of the distance D_BODY and that of the emissive power used by an antenna in use have been described above as two alternative implementations, nothing precludes considering other embodiments in which these two aspects are combined. By way of example without any limitation, the alternative selection of the antennas can be triggered if not only D_BODY is less than the threshold S_BODY, but also if the emissive power in use exceeds a given threshold.

Finally, the disclosure has been described until now by considering that the alternative selection of the antennas in particular includes the generation of commands by the control device 140 and the transmission of these commands to the switching means 130. However, the selection can also consist in an identification of an antenna in a list of antennas, and the transmission of this item of identification information to means separate from the control device 140 and able to generate (on the basis of said item of identification information) an appropriate command addressed to the switching means 130.

One or more exemplary aspects of the present disclosure remedies all or part of the drawbacks of the prior art, in particular those described above, by making provision for a solution that makes it possible to comply with the exposure limits expressed in terms of average SAR (i.e. SAR averaged over a given time period) more efficiently than the solutions of the prior art.

The term “more efficient” here refers to a solution guaranteeing an excellent uplink speed, and therefore an excellent quality of service, and with a minimal implementation cost (financial, hardware, ground surface occupied).

Although the present disclosure has been described with reference to one or more examples, workers skilled in the art will recognize that changes may be made in form and detail without departing from the scope of the disclosure and/or the appended claims.

What is claimed is:

1. A method for controlling operation of a wireless communication device including a plurality of antennas configured to spatially radiate in separate areas, said method comprising:
alternating selecting of said antennas to transmit a communication signal, said selecting being performed so that an average specific absorption rate generated by each antenna over a given time period is less than a determined threshold, considering a given control distance between the communication device and a human body.

2. The method as claimed in claim 1, wherein the number of antennas is strictly greater than two.

3. The method as claimed in claim 1, wherein an emissive power used by a selected antenna is a maximum emissive power of the wireless communication device.

4. The method as claimed in claim 1, said method including evaluating a distance between the communication device and the human body, wherein execution of the selecting is consequent on said evaluated distance being less than a given threshold.

5. The method as claimed in claim 1, said method including evaluating an emissive power used by an antenna of the plurality of antennas in use to transmit said communication signal, wherein execution of the selecting is consequent on said evaluated emissive power being greater than a given threshold.

6. The method as claimed in claim 5, wherein the evaluating the emissive power includes a set of evaluations of the emissive power by respectively considering a set of control distance values, said evaluated emissive power being equivalent to a maximum emissive power obtained from said set of evaluations of the emissive power.

7. The method as claimed in claim 1, wherein the alternating selecting of the antennas is performed with a fixed periodicity.

8. The method as claimed in claim 1, wherein the alternating selecting of the antennas is performed with a dynamic periodicity.

9. The method as claimed in claim 1, wherein said control distance is zero.

10. The method as claimed in claim 1, wherein said time period is equal to six minutes.

11. The method as claimed in claim 1, wherein the determined threshold of said average specific absorption rate is equal to 2 W/kg.

12. The method as claimed in claim 1, wherein a maximum emissive power of the communication device is greater than or equal to 20 mW.

13. A non-transitory computer readable recording medium on which is recorded a computer program which when executed by a processor of a control device configures the control device to method for controlling operation of a wireless communication device including a plurality of antennas configured to spatially radiate in separate areas, said method comprising:
alternating selecting of said antennas to transmit a communication signal, said selecting being performed so that an average specific absorption rate generated by each antenna over a given time period is less than a determined threshold, considering a given control distance between the communication device and a human body.

14. A control device comprising:
at least one processor; and
at least one non-transitory computer readable medium comprising instructions stored thereon which when executed by the at least one processor configure the control device to implement a method for controlling operation of a wireless communication device including a plurality of antennas configured to spatially radiate in separate areas, said method comprising:
alternating selecting of said antennas to transmit a communication signal, said selecting being performed so that an average specific absorption rate generated by each antenna over a given time period is less than a determined threshold, considering a given control distance between the communication device and a human body.

15. A wireless communication device comprising the control device as claimed in claim 14 and the plurality of antennas.
